(19) United States
(12) Patent Application Publication
(10) Pub. No.: US 2004/0056582 A1
(43) Pub. Date: Mar. 25, 2004

(54) Display device

(76) Inventors: Tomoki Nakamura, Chiba (JP); Yuuichi Kijima, Chosei (JP); Yoshiyuki Kaneko, Hachioji (JP); Toshifumi Ozaki, Mobara (JP); Shigemi Hirasawa, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/664,966

(22) Filed: Sep. 22, 2003

(30) Foreign Application Priority Data
Sep. 20, 2002 (JP) 2002-274447

(51) Int. Cl. H01J 29/80

(52) U.S. Cl. 313/402

(57) ABSTRACT

To provide a display device having the long lifetime and the high reliability by preventing the generation of a spark or a dark current between terminals of cathode lines and an anode, a shielding member is arranged between the terminals of the cathode lines and the anode so as to ensure shielding between the terminals and the anode.

### BACKGROUND OF THE INVENTION

1. Field of the Invention

The present invention relates to a display device which utilizes an emission of electrons into a vacuum which is defined between a face substrate and a back substrate, and more particularly, to a display device which can arrange cathode lines having electron emitting sources and control electrodes which control a quantity of electrons led or emitted from the electron emitting sources and, at the same time, can exhibit stable display characteristics by holding a vacuum between the face substrate and the back substrate.

2. Description of the Related Art

As a display device which exhibits the high brightness and the high definition, color cathode ray tubes have been widely used conventionally. However, along with the recent request for the higher quality of images of information processing equipment or television broadcasting, the demand for planar displays (panel displays) which are light in weight and require a small space while exhibiting the high brightness and the high definition has been increasing.

As typical examples, liquid crystal display devices, plasma display devices and the like have been put into practice. Further, particularly, as display devices which can realize the higher brightness, it is expected that various kinds of panel-type display devices including a display device which utilizes an emission of electrons from electron emitting sources into a vacuum (hereinafter, referred to as “an electron emission type display device” or “a field emission type display device”) and an organic EL display which is characterized by low power consumption will be put into practice.

Among such panel type display devices, as the above-mentioned field emission type display device, a display device having an electron emission structure which was invented by C. A. Spindt et al, a display device having an electron emission structure of a metal-insulator-metal (MIM) type, a display device having an electron emission structure which utilizes an electron emission phenomenon based on a quantum theory tunneling effect (also referred to as “surface conduction type electron emitting source,), and a display device which utilizes an electron emission phenomenon having a diamond film, a graphite film and carbon nanotubes and the like have been known.

One type of field emission type display device includes a back substrate which forms cathode lines having electron-emission-type electron emitting sources and a control electrode on an inner surface thereof and a face substrate which forms an anode and a fluorescent material on an inner surface which faces the back substrate, wherein both substrates are laminated to each other by inserting a sealing frame between inner peripheries of both substrates and the inside thereof is evacuated. Further, to set a gap between the back substrate and the face substrate to a given value, gap holding members are provided between both substrates.

FIG. 16 is a plan view of a back substrate for explaining the schematic constitution of a field emission type display device and also is a schematic view as viewed from the side of a face substrate not shown in the drawing. The back substrate 1 is configured such that on an insulation substrate which is preferably made of glass, alumina or the like, a plurality of cathode lines 2 having electron emitting sources and control electrodes of plate member 4 constituted of a plurality of strip-like electrode elements are formed. The cathode lines 2 extend in one direction on the back substrate 1 and are arranged in plural numbers in parallel in another direction which crosses one direction. The cathode lines 2 are patterned by printing a conductive paste containing silver or the like and electron emitting sources are arranged on the surface (face substrate side) of the cathode lines 2. Extended end portions of the cathode lines 2 are pulled out to the outside of a frame body 90 which constitutes a sealing frame as cathode-line lead lines 20, while another end portions extend to terminals 22 which are arranged inside the frame body 90 and outside the display region AR.

On the other hand, the control electrodes 4 are manufactured as separate members and formed on the back substrate 1 at positions described later. That is, the control electrodes 4 are arranged close to and above the cathode lines 2 having the electron emitting sources (face substrate side) and, at the same time, face the cathode lines 2 with a given distance therebetween over the whole area of the display region AR. A large number of strip-like electrode elements 41 which constitute the control electrodes 4 extend in the above-mentioned another direction and are juxtaposed in the above-mentioned one direction. The strip-like electrodes 41 have open holes which constitute electron passing apertures at crossing portions thereof with the above-mentioned electron emitting sources on the cathode lines 2. Electrons which are emitted from the electron emitting sources of the cathode lines 2 pass through the electron passing apertures toward the face substrate side (anode side) and pixels are formed over the crossing portions.

The control electrodes 4 are preferably formed such that a thin plate (having a thickness of about 0.05 mm, for example) mainly made of aluminum or iron is formed into a large number strip-shaped thin plates by etching using a photolithography technique, wherein a large number of electron passing apertures are formed in the strip-shaped thin plate. The control electrodes 4 are fixed to the back substrate 1 by press members 60 or the like formed of an insulation body made of glass material at a fixing portion which is arranged outside a display region AR. In the vicinity of the fixing portion or in the vicinity of the frame body 90, lead lines (control-electrode lead lines) 40 are connected to the control electrodes 4 and the lead lines 40 are pulled out to the outer periphery of the display device. Here, it maybe possible to impart a function of the press member 60 to the frame body 90. Then, in response to a potential difference between the cathode lines 2 and the control electrodes 4, an emission quantity (including ON and OFF) of electrons from electron emitting sources provided to the cathode lines 2 is controlled.

On the other hand, the face substrate not shown in the drawing is formed of an insulation material having light transmissivity such as glass or the like and forms anodes and fluorescent materials on an inner surface thereof. The fluorescent materials are formed corresponding to pixels which are formed on the crossing portions between the cathode lines 2 and the control electrodes 4. In the drawing, x indicates the extension direction of the control electrodes 4, y indicates the extension direction of the cathode lines 2, and z indicates the direction which is perpendicular to the substrate surfaces of the back substrate and the face substrate.

The back substrate 1 and the face substrate having the above-mentioned constitution are sealed together by way of the frame body 90 and the inside sealed by the sealing frame 90 is evacuated through an exhaust hole 11 so that a vacuum of 10⁻⁵ to 10⁻⁷ Torr is created in the inside thus forming a field emission type display device. The above-mentioned electron emitting source is constituted of carbon nanotubes (CNT), diamond-like carbons (DLC), other field emission cathode material or other field emission shape.

Here, as literatures which disclose prior art which is relevant to this type of electron emission type display device, except for the constitution of control electrodes formed of the strip-like electrode elements, Japanese Unexamined Patent Publication 1995-326306, Japanese Unexamined Patent Publication 1999-144652, Japanese Unexamined Patent Publication 2000-323078, and Japanese Unexamined Patent Publication 2001-338528 and the like are named.

### SUMMARY OF THE INVENTION

The above-mentioned electron emission type display device is of a type in which electrons from the electron emitting source pass through apertures formed in the control electrode and impinge on a fluorescent material of an anode and excite the fluorescent material to emit light and to perform a display. This display device has the excellent constitution which enables a planar display which exhibits the excellent characteristics such as high brightness and high definition, is light-weighted and requires a small space.

However, in spite of such an excellent constitution, the electron emission type display device has following drawbacks to be solved. That is, in the above-mentioned electron emission type display device having the cathode lines as shown in FIG. 16, a distance between the cathode lines on the back substrate and the anode on the face substrate is set to several mm and, under such a constitution, the display device is operated by applying a cathode voltage of 0V to the cathode lines, by applying an anode voltage of several KV to some ten KV to the anode, and by applying a grid voltage of about 100 V to the control electrode. However, the terminals of the cathode lines extend and are present outside the control electrodes as well as outside the display region AR and hence, the anode and the cathode lines directly face each other at the terminal portions. Further, the terminals exhibit edge portions and hence, the display device has a possibility that a spark or a dark current is easily generated between the terminals and the anode. When the spark or the dark current is generated, the display becomes unstable and, at the same time, the display is degraded and hence, the reliability of display is damaged. Further, an undesired current which does not contribute to the display flows so that the extension of lifetime is impeded. In this manner, the electron emission type display device has the above-mentioned drawbacks and the means for solving such drawbacks are demanded.

Accordingly, it is an object of the present invention to provide a reliable display device which is capable of performing display of high definition and exhibits the long lifetime by preventing the generation of a spark or a dark current between the terminals of the cathode lines and an anode.

To achieve the above-mentioned object, the present invention is characterized by inserting a shield member between the terminals of cathode lines and an anode so as to ensure shielding between the terminals and an anode. Hereinafter, typical constitutions of the display device according to the present invention are described.

The display device according to the present invention includes a face substrate which has an anode and a fluorescent material on an inner surface thereof, a plurality of cathode lines which extend in one direction, are juxtaposed in another direction which crosses the above-mentioned one direction, and has electron emitting sources, control electrodes which are constituted by arranging a plurality of strip-like electrode elements which cross the above-mentioned cathode lines in a non-contact state within a display region in parallel, extend in the above-mentioned another direction and are juxtaposed in the above-mentioned one direction, and have electron passing apertures for allowing electrons from the electron emitting sources to pass therethrough toward the above-mentioned face substrate, a back substrate which has the above-mentioned control electrodes and the above-mentioned cathode lines on an inner surface thereof and faces the face substrate with a given distance therebetween, and a frame body which is inserted between the above-mentioned face substrate and the back substrate and is arranged around the above-mentioned display region to hold the above-mentioned given distance.

Then, the cathode lines have extending one end sides thereof terminated outside the display region and inside the frame body, and a shield member is inserted between the terminals and the anode so as to ensure shielding between the terminals and the anode.

As the above-mentioned shield member, a member having the same shape as strip-like electrode elements which do not have the above-mentioned electron passing apertures or a strip-like electrode element which has the above-mentioned electron passing apertures can be used. Further, the shield member may be constituted of an insulation layer which covers the above-mentioned terminals, and the shield member may be also constituted of a separate frame body which has a substantially same height as the frame body.

According to the above-mentioned constitutions, by inserting the shield member between the terminals of the cathode lines and the anode to ensure shielding between the terminals of the cathode lines and the anode, it is possible to prevent the generation of a spark and an undesired current whereby it is possible to provide a display device which exhibits high reliability and long lifetime.

Further, a display device according to the present invention includes a face substrate which has an anode and a fluorescent material on an inner surface thereof, a plurality of cathode lines which extend in one direction, are juxtaposed in another direction which crosses the above-mentioned one direction, and has electron emitting sources, control electrodes which are constituted by arranging a plurality of strip-like electrode elements in parallel which cross the above-mentioned cathode lines in a non-contact state within a display region, extend in the above-mentioned another direction and are juxtaposed in the above-mentioned one direction, and have electron passing apertures for allowing electrons from the electron emitting sources to pass therethrough toward the above-mentioned face substrate, a back substrate which has the above-mentioned control electrodes and the above-mentioned cathode lines on an inner surface thereof and faces the face substrate with a given distance therebetween, and a frame body which is inserted between the above-mentioned face substrate and the back substrate and is arranged around the above-mentioned display region to hold the above-mentioned given distance.

The above-mentioned cathode lines have extending one end sides thereof terminated at positions outside the above-mentioned display region and where the cathode lines are superposed on the frame body and hence, it is possible to ensure shielding between the terminals and the above-mentioned anode using the frame body whereby it is unnecessary to add another member for shielding and a cost can be also reduced.

It is needless to say that the present invention is not limited to the above-mentioned constitutions and constitutions of embodiments described later and various modifications can be made without departing from the technical concept of the present invention.

### BRIEF DESCRIPTION OF THE DRAWINGS

FIG. 1 is a plan view for schematically explaining the constitution of an essential part of a back panel side for explaining the first embodiment of a display device according to the present invention.

FIG. 2 is a cross-sectional view of an essential part taken along a line A-A in FIG. 1.

FIG. 3 is a plan view for schematically explaining the constitution of an essential part of a back panel side for explaining the second embodiment of a display device according to the present invention.

FIG. 4 is a cross-sectional view of an essential part taken along a line B-B in FIG. 3.

FIG. 5 is a plan view for schematically showing the constitution of an essential part of a back panel side for explaining the third embodiment of a display device according to the present invention.

FIG. 6 is a cross-sectional view of an essential part taken along a line C-C in FIG. 5.

FIG. 7 is a plan view for schematically showing the constitution of an essential part of a back panel side for explaining the fourth embodiment of a display device according to the present invention.

FIG. 8 is a cross-sectional view of an essential part taken along a line D-D in FIG. 7.

FIG. 9 is a plan view for schematically showing the constitution of an essential part of a back panel side for explaining the fifth embodiment of a display device according to the present invention.

FIG. 10 is a plan view for schematically showing the constitution of an essential part of a back panel side for explaining the sixth embodiment of a display device according to the present invention.

FIG. 11 is a plan view for schematically showing the constitution of an essential part of a back panel side for explaining the seventh embodiment of a display device according to the present invention.

FIG. 12 is a cross-sectional view of an essential part taken along a line E-E in FIG. 11.

FIG. 13 is a plan view for schematically showing the constitution of an essential part of a back panel side for explaining the eighth embodiment of a display device according to the present invention.

FIG. 14 is a developed perspective view for schematically showing the whole constitution of the display device of the present invention.

FIG. 15 is an explanatory view of an example of an equivalent circuit of the display device of the present invention.

FIG. 16 is a plan view of a back substrate for explaining the schematic constitution of a field emission type display device.

### DESCRIPTION OF THE PREFERRED EMBODIMENTS

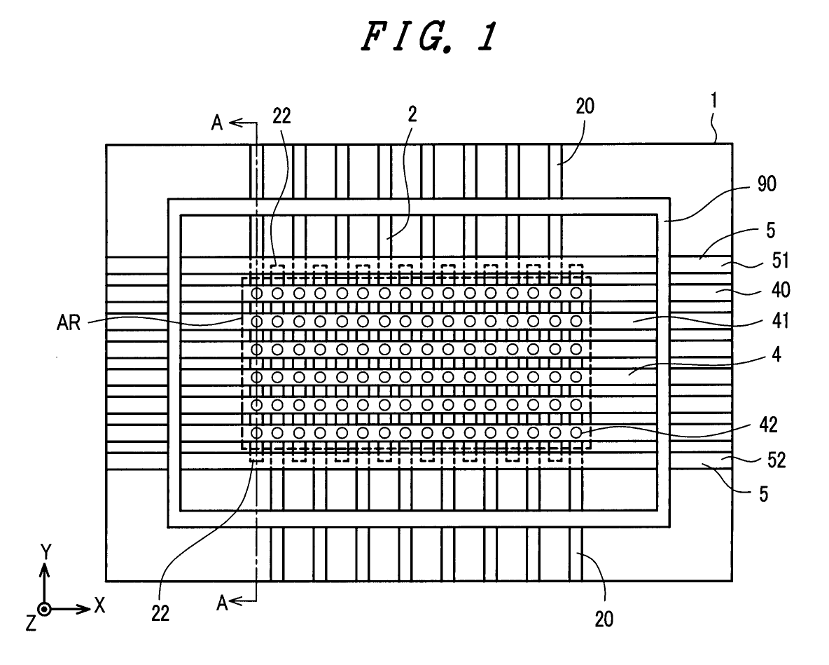

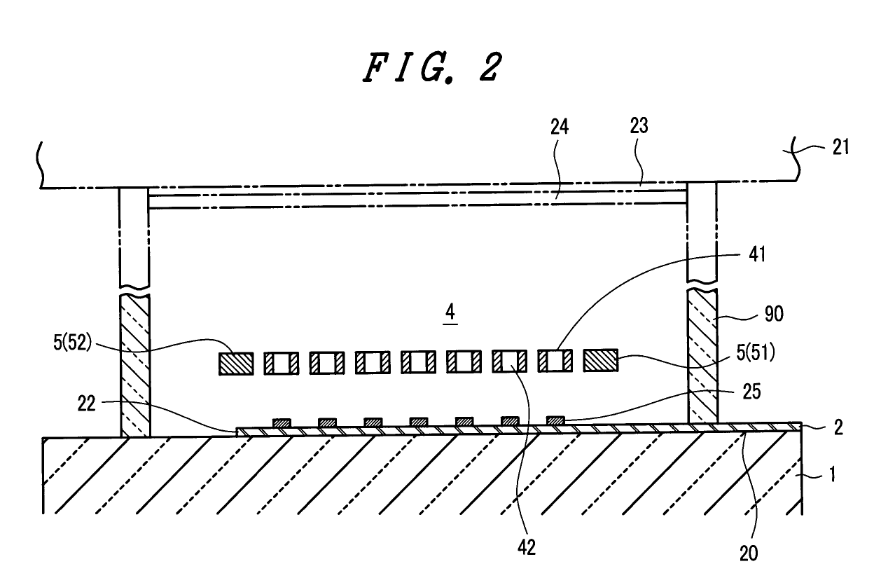

Preferred embodiments of the present invention are explained in detail hereinafter in conjunction with drawings which show these embodiments. FIG. 1 is a plan view for schematically showing the constitution of an essential part at a back substrate side for explaining the first embodiment of a display device according to the present invention, and FIG. 2 is a cross-sectional view of an essential part taken along a line A-A in FIG. 1. Here, in FIG. 2, the arrangement relationship among a face substrate 21, an anode 23 and a fluorescent material 24 is indicated by a phantom line.

In FIG. 1 and FIG. 2, reference symbol 1 indicates a back substrate and the back substrate 1 is constituted of an insulation substrate suitably formed of glass, alumina or the like. Reference symbol 2 indicates cathode lines which extend in one direction (y direction) on the back substrate 1 and are juxtaposed in a plural number in another direction (x direction) which crosses one direction. The cathode lines 2 are formed by patterning a conductive paste containing silver or the like by printing or the like and electron emitting sources 25 are formed on surfaces thereof (face substrate 21 side). Carbon nanotubes, for example, are used as the electron emitting sources 25 as described previously.

Further, extending one end portions of the cathode lines 2 are pulled out as cathode-line lead lines 20 to the outside of a frame body 90 which constitutes a sealing frame, while another end portions of the cathode lines 2 extend to terminals 22 inside the frame body 90 and outside a display region AR. In this embodiment, the cathode lines 2 are configured such that the cathode-line lead lines 20 are arranged every other one line at upper and lower ends of the back substrate 1 on the drawing. Reference symbol 4 indicates control electrodes and these control electrodes 4 are arranged above (face substrate 21 side) and close to the cathode lines 2 having the electron emitting sources 25, that is, close to the cathode lines 2 by approximately 0.01 mm or less. Further, the control electrodes 4 are arranged over at least the whole area of the display region AR to face the cathode lines 2.

The control electrodes 4 and the cathode lines 2 are electrically insulated from each other. Reference symbol 40 indicates control-electrode lead lines and these control-electrode lead lines 40 are configured to be pulled out to both of left and right ends of the back substrate 1 on the drawing. Reference symbol 41 indicates a plurality of strip-like electrode elements which constitute the control electrodes 4. The strip-like electrode elements 41 are formed of an iron-based stainless steel material or an iron material and has a plate thickness of approximately 0.025 mm to 0.150 mm. The control electrodes 4 are constituted by making these strip-like electrode elements 41 extend in the x direction and juxtaposed in the y direction. It is preferable that the strip-like electrode elements 41 are integrally formed with the control-electrode lead lines 40. Reference symbol 42 indicates electron passing apertures which are constituted of holes formed in the strip-like electrode elements 41. One or a plurality of electron passing apertures 42 are arranged at a crossing portion between the strip-like electrode element 41 and the cathode line 2 and at a position coaxial with the electron emitting source 25 so as to allow the electrons emitted from the electron emitting source 25 to pass therethrough toward the anode 23. The distance between the anode 23 and the above-mentioned control electrodes 4 is set to several mm, that is, 3 mm, for example.

Reference symbol 5 indicates strip-like shield members. The shield members 5 are arranged close to the outermost control electrodes 4 such that the shield members 5 cover the terminals 22 of the cathode lines 2 from the anode 23. Using two shield members 5 (51, 52), the terminals 22 and the anode 23 are shielded from each other. In this example, although a distance between the shield members 5 and the anode 23 is set equal to a distance between the control electrodes 4 and the anode 23, the distance may be determined based on the shape, the potential or the like of the shield members 5.

The shield members 5 may have the same specification as the above-mentioned strip-like electrode elements 41 except that the shield members 5 do not have the electron passing apertures 42. Alternatively, the shield members 5 may use the strip-like electrode element 41 per se. In this case, by adopting the arrangement in which the electron passing apertures 42 and the above-mentioned terminals are not superposed each other, the further shielding effect can be expected. Further, by electrically connecting the shield members 5 and the control electrodes 4, it is possible to enhance the shielding effect.

Based on such a constitution, electrons emitted from the electron emitting sources 25 pass through the electron passing apertures 42 of the control electrode 4 to which a grid voltage of approximately 100V is applied while receiving a control and impinge on the fluorescent material 24 formed on the anode 23 of the face substrate 21 to which an anode voltage of several KV to several tens KV is applied whereby light is emitted from the fluorescent material 24 to perform a given display. During such an operation, according to the constitution of this embodiment, the terminals 22 of the cathode lines 2 and the anode 23 are shielded from each other by the shielding materials 5 and hence, it is possible to prevent the anode potential from affecting the terminals 22 so that the generation of a spark or a dark current between the terminals 22 and the anode 23 can be suppressed, the degradation of display can be obviated, whereby the display device which can perform the high-definition display and exhibits the high reliability and the long lifetime can be obtained.

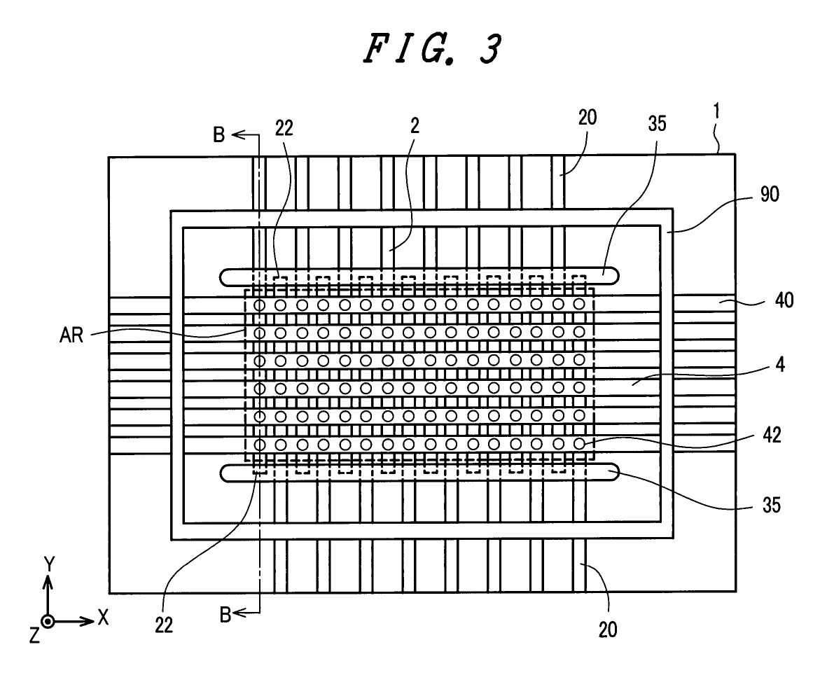

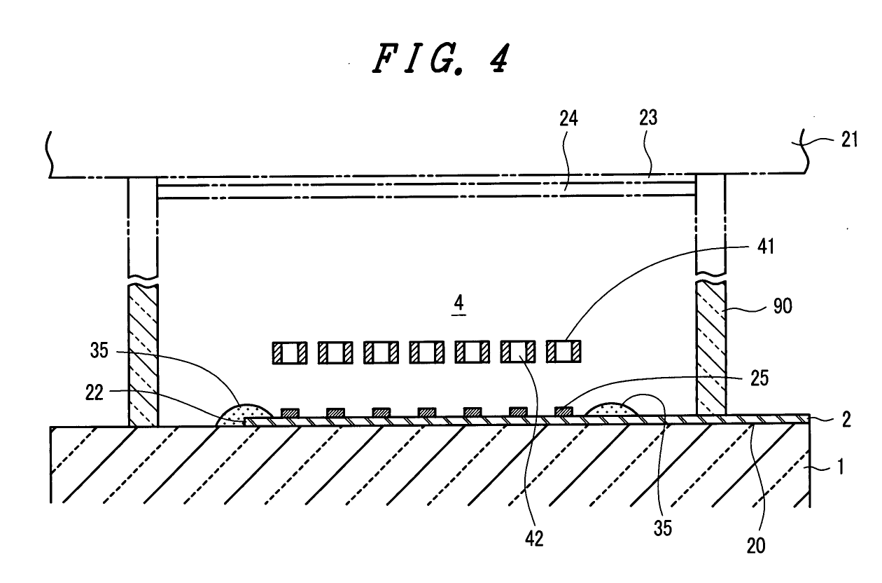

FIG. 3 is a plan view schematically showing the constitution of an essential part of a back substrate side for explaining the second embodiment of the display device according to the present invention. Further, FIG. 4 is a cross-sectional view of an essential part taken along a line B-B in FIG. 3. Parts having the functions identical to the parts shown in FIG. 1 and FIG. 2 are given same symbols. Here, in FIG. 4, the arrangement relationship among a face substrate 21, an anode 23 and a fluorescent material 24 is indicated by a phantom line in the same manner as the display device shown in FIG. 2.

In FIG. 3 and FIG. 4, reference symbol 35 indicates shield members. The shield members 35 are formed of an insulating material such as frit glass and are applied and arranged to cover terminals 22. Since the shield members 35 are arranged in a vacuum atmosphere, it is preferable to constitute the shield members 35 using a material which emits a small amount of gas. When the shield members 35 are formed of the material such as frit glass which requires the high temperature treatment, by baking the material before forming the electron emitting sources 25, it is possible to expect an advantageous effect that the adverse influence to the electron emitting sources 25 can be reduced.

Due to such a constitution of this embodiment, the terminals 22 can be completely shielded by the shield members 35 and hence, a drawback attributed to the turnaround of an electric field can be solved. Accordingly, not to mention the above-mentioned effect to suppress the generation of the spark and the dark current, the workability can be enhanced by integrally handling the shield members 35 and the back substrate 1 and, at the same time, it is possible to obtain the display device which can perform display with high definition and can exhibit high reliability and long lifetime.

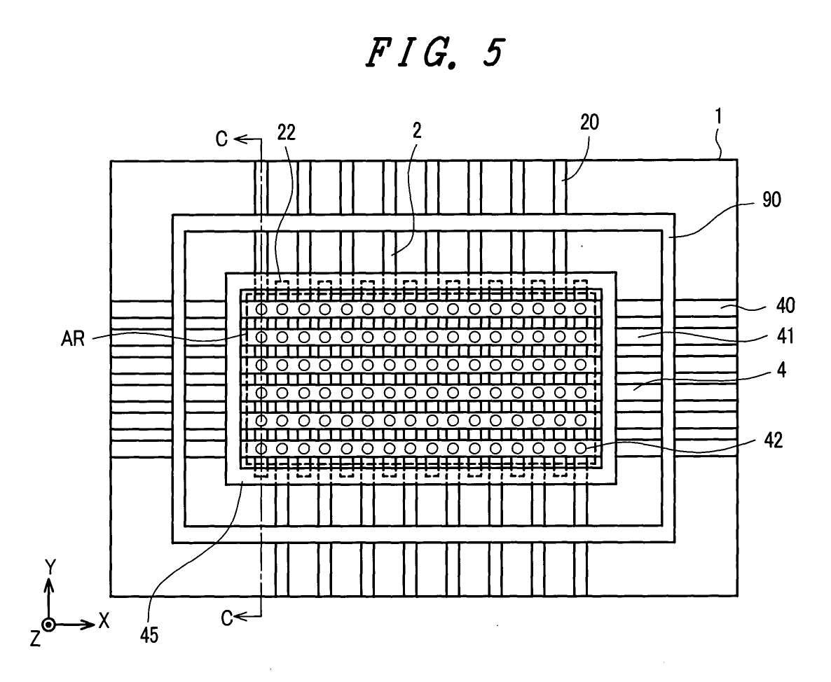

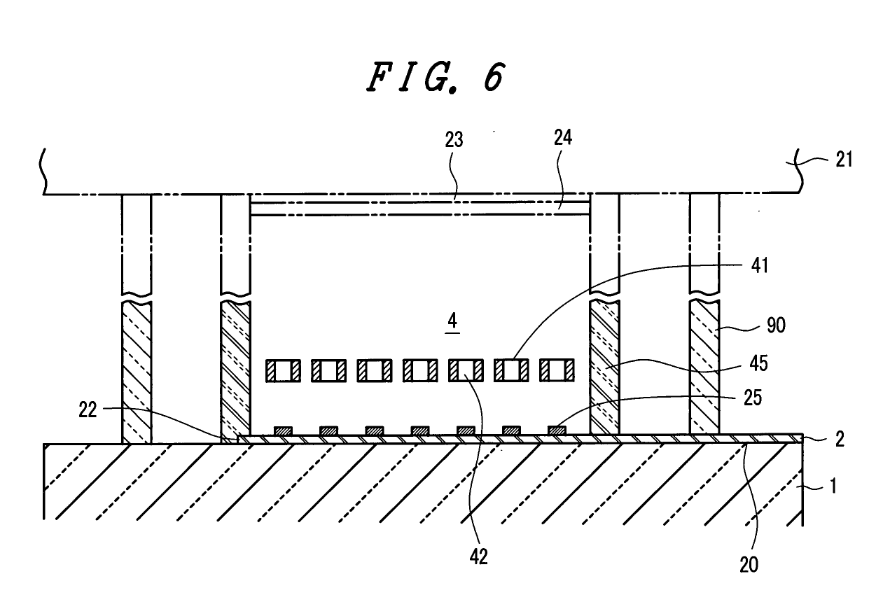

FIG. 5 is a plan view schematically showing the constitution of an essential part of a back substrate side for explaining the third embodiment of the display device according to the present invention. Further, FIG. 6 is a cross-sectional view of an essential part taken along a line C-C in FIG. 5. In FIG. 5 and FIG. 6, parts having the functions identical to the parts shown in FIG. 1 to FIG. 4 are given same symbols. Here, in FIG. 6, the arrangement relationship among a face substrate 21, an anode 23 and a fluorescent material 24 is indicated by a phantom line in FIG. 6 in the same manner as the display device shown in FIG. 2 and FIG. 4.

In FIG. 5 and FIG. 6, reference symbol 45 indicates a shield member in a frame shape. The shield member 45 is formed of a glass plate or a ceramic plate and is arranged such that a lower end surface thereof covers terminals 22 inside a frame body 90 which constitutes a sealing frame. A height of the shield member 45 is set equal to or lower than a height of the frame body 90. A display region AR is set inside the shield member 45.

Due to such a constitution of this embodiment, the terminals 22 can be completely shielded by the shield member 45 and hence, a drawback attributed to the turnaround of an electric field can be solved. Accordingly, not to mention the above-mentioned effect to suppress the generation of the spark and the dark current, the shield member 45 cooperates with the frame body 90 to set a distance between a back substrate 1 and a face substrate 21 to a fixed value thus preventing the degradation of display, whereby it is possible to obtain the display device which can perform display with high definition and can exhibit high reliability and long lifetime.

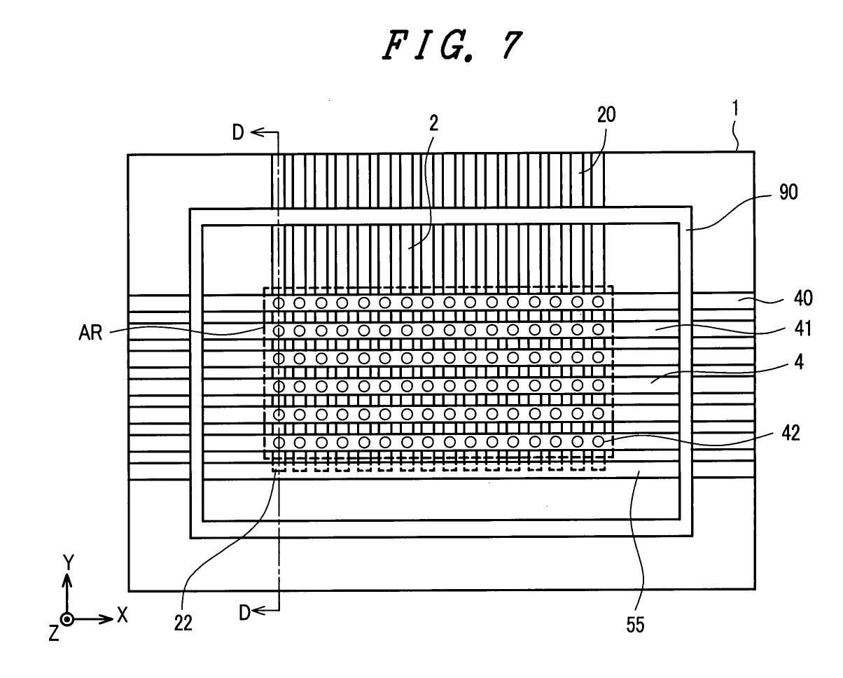

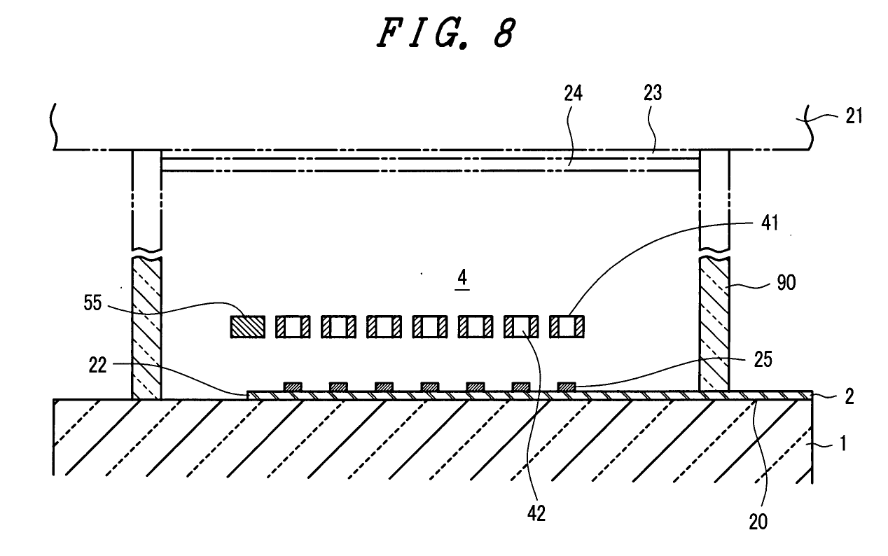

FIG. 7 is a plan view schematically showing the constitution of an essential part of a back substrate side for explaining the fourth embodiment of the display device according to the present invention. Further, FIG. 8 is a cross-sectional view of an essential part taken along a line D-D in FIG. 7. In FIG. 7 and FIG. 8, parts having the functions identical to the parts shown in FIG. 1 to FIG. 6 are given same symbols. Here, in FIG. 8, the arrangement relationship among a face substrate 21, an anode 23 and a fluorescent material 24 is indicated by a phantom line in FIG. 8 in the same manner as the display device shown in FIG. 2, FIG. 4 and FIG. 6.

In the fourth embodiment shown in FIG. 7 and FIG. 8, cathode-line lead lines 20 of cathode lines 2 are arranged only one end face side of the back substrate 1 and hence, this embodiment differs in constitution from the above-mentioned respective embodiments. Due to such an arrangement of the cathode-line lead lines 20 of the cathode lines 2, the terminals 22 are also arranged in one row in the y direction and hence, only one shield member 55 is arranged so as to ensure shielding between the terminals 22 and an anode 23. The constitution, the arrangement, the position and the like of the shield member 55 adopt the same constitution as that of the first embodiment explained in conjunction with FIG. 1 and FIG. 2.

Due to such a constitution of this embodiment, not to mention the above-mentioned effect to suppress the generation of the spark and the dark current, since the cathode-line lead lines 20 are pulled out only to the one end face side of the back substrate 1, it is possible to obtain an advantageous effect that the connection with external circuits is facilitated, whereby it is possible to obtain the display device which can perform display with high definition and can exhibit high reliability and long lifetime.

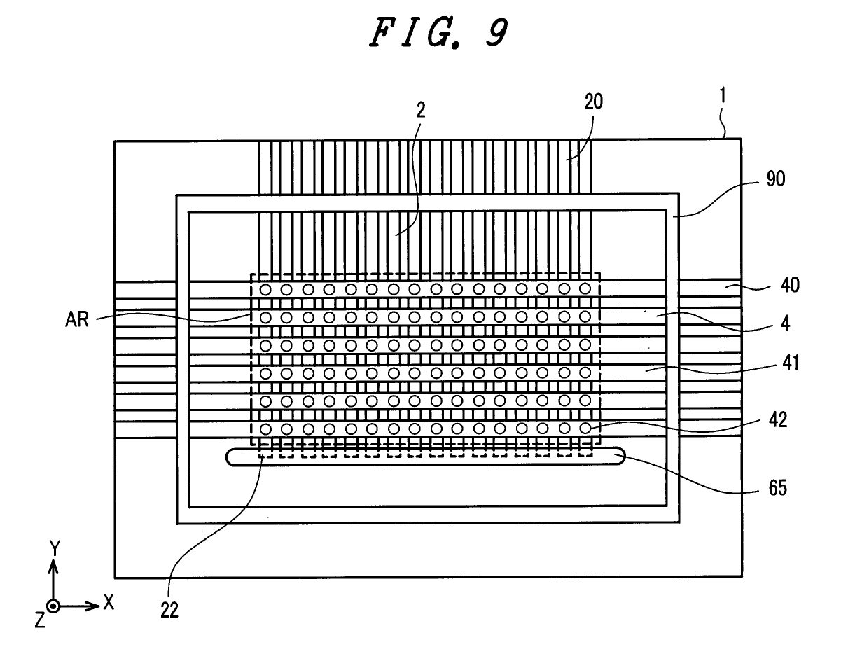

Next, FIG. 9 is a plan view schematically showing the constitution of an essential part of a back substrate side for explaining the fifth embodiment of the display device according to the present invention. In FIG. 9, parts having the functions identical to the parts shown in FIG. 1 to FIG. 8 are given same symbols. In the embodiment shown in FIG. 9, in the same manner as the embodiment shown in FIG. 7 and FIG. 8, cathode-line lead lines 20 of cathode lines 2 are arranged only at one end face side of the back substrate 1. In such a constitution, the terminals 22 are covered with and are shielded by a shield member 65 which constitutes an insulator such as frit glass in the same manner as the second embodiment explained in conjunction with FIG. 3 and FIG. 4.

By adopting the constitution of this embodiment, it is possible to obtain the display device which can perform the high-definition display and can exhibit high reliability and long lifetime while obtaining the advantageous effects of the above-mentioned second and fourth embodiments simultaneously.

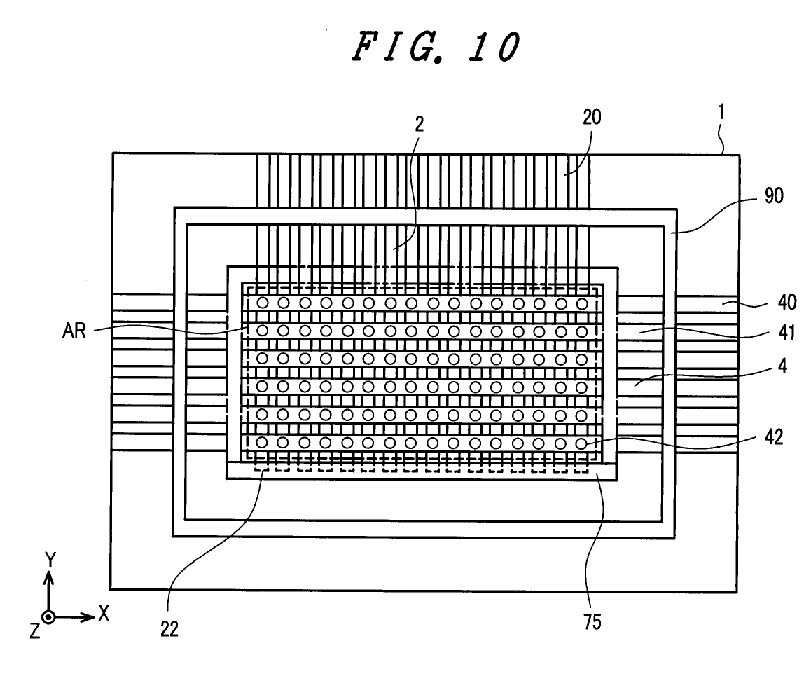

Next, FIG. 10 is a plan view schematically showing the constitution of an essential part of a back substrate side for explaining the sixth embodiment of the display device according to the present invention. In FIG. 10, parts having the functions identical to the parts shown in FIG. 1 to FIG. 9 are given same symbols. In the embodiment shown in FIG. 10, in the same manner as the embodiment shown in FIG. 7 to FIG. 9, cathode-line lead lines 20 of cathode lines 2 are arranged only at one end face side of the back substrate 1. In such a constitution, the terminals 22 are covered with a plate-like shield member 75 which is formed of a glass plate or a ceramic plate so as to provide shielding between an anode 23 and the terminals 22 in the same manner as the third embodiment explained in conjunction with FIG. 5 and FIG. 6.

By adopting the constitution of this embodiment, it is possible to obtain the display device which can perform the high-definition display and can exhibit high reliability and long lifetime while obtaining the advantageous effects of the above-mentioned third and fourth embodiments simultaneously.

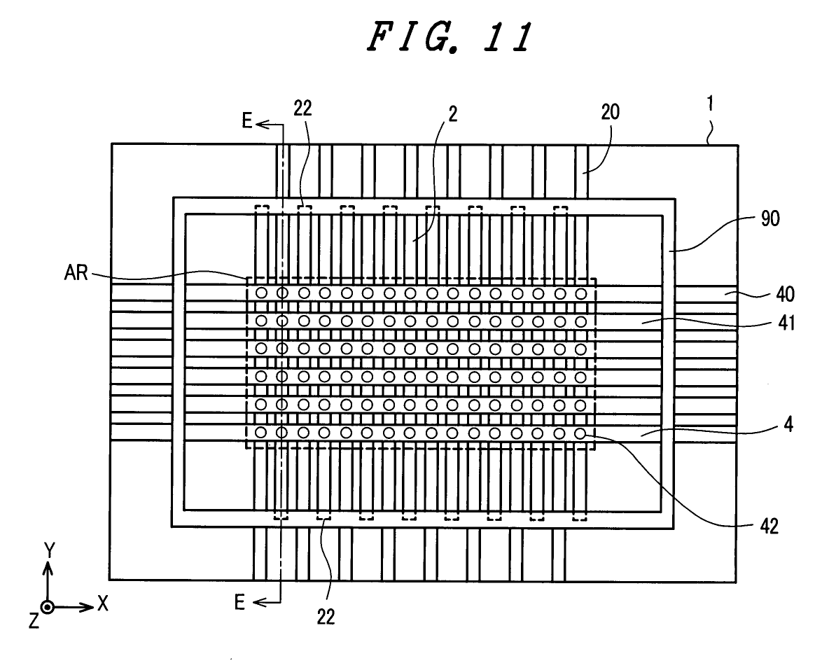

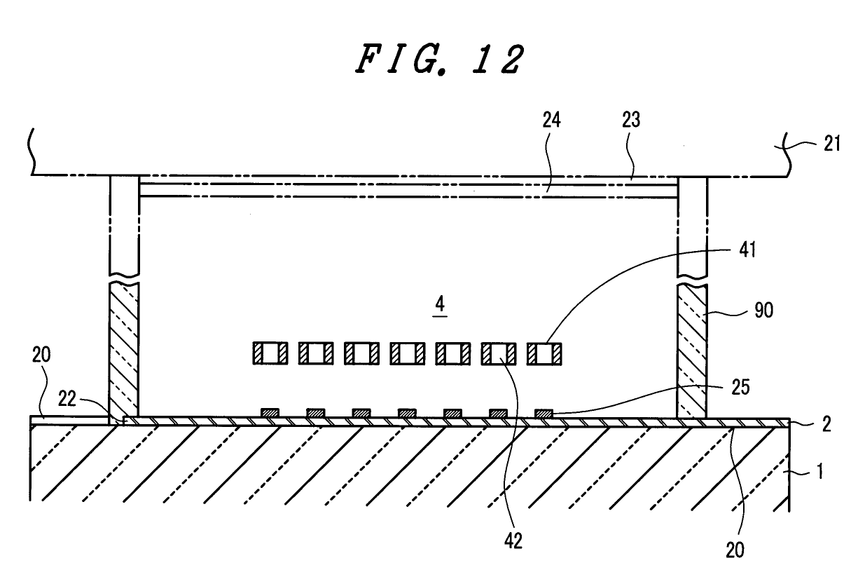

FIG. 11 is a plan view schematically showing the constitution of an essential part of a back substrate side for explaining the seventh embodiment of the display device according to the present invention. Further, FIG. 12 is a cross-sectional view of an essential part taken along a line E-E in FIG. 11. In FIG. 11 and FIG. 12, parts having the functions identical to the parts shown in FIG. 1 to FIG. 10 are given same symbols. Here, in FIG. 12, the arrangement relationship among a face substrate 21, an anode 23 and a fluorescent material 24 is indicated by a phantom line in the same manner as the display device shown in FIG. 2, FIG. 4, FIG. 6 and FIG. 8.

In the seventh embodiment shown in FIG. 11 and FIG. 12, terminals 22 of cathode lines 2 are made to extend below a frame body 90 which constitutes a sealing frame and superposed on the frame body 90 whereby the frame body 90 is also served as a shield member which performs shielding between the terminals 22 and the anode 23. Here, in this embodiment, cathode-line lead lines 20 of the cathode lines 2 are arranged at both end faces of the back substrate 1 every other line.

Due to such a constitution of this embodiment, it is possible to make the existing constitutional member also function as the shield member, not to mention the above-mentioned advantageous effect of suppressing the generation of the spark or the dark current, the enhancement of operability and the reduction of cost can be expected whereby it is possible to obtain the display device which can perform the high-definition display and can exhibit high reliability and long lifetime.

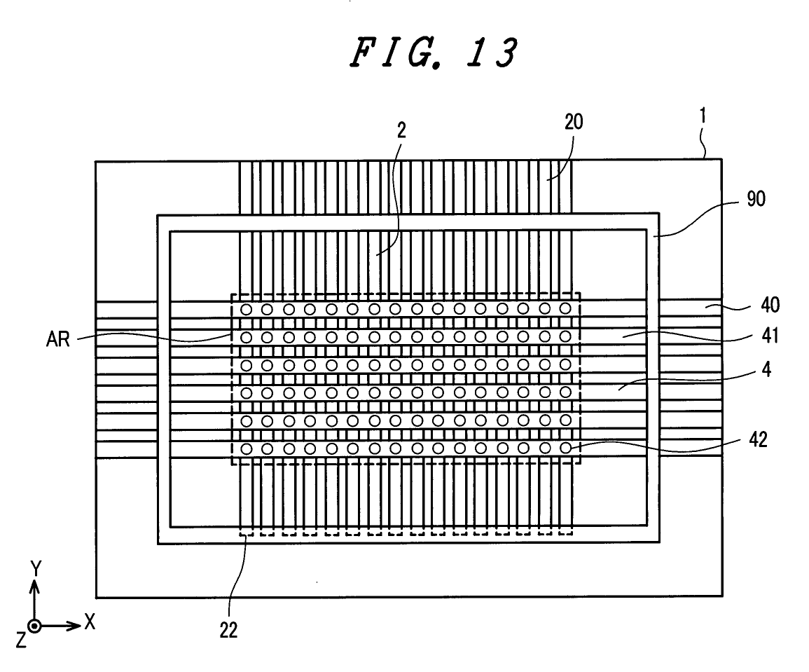

FIG. 13 is a plan view schematically showing the constitution of an essential part of a back substrate side for explaining the eighth embodiment of the display device according to the present invention. In FIG. 13, parts having the functions identical to the parts shown in FIG. 1 to FIG. 12 are given same symbols. In the eighth embodiment shown in FIG. 13, cathode-line lead lines 20 of the cathode line 2 are arranged only at one end face side of a back substrate 1 and terminals 22 of cathode lines 2 are arranged in one line in the y direction and are made to extend below a frame body 90 which constitutes a sealing frame and superposed on the frame body 90.

Due to such a constitution of this embodiment, it is possible to make the existing constitutional member also function as the shield member, not to mention the above-mentioned advantageous effect of suppressing the generation of the spark or the dark current, the enhancement of operability and the reduction of cost can be expected. Further, it is possible to obtain the display device which can perform the high-definition display and can exhibit high reliability and long lifetime while obtaining the advantageous effect of the fourth embodiment simultaneously.

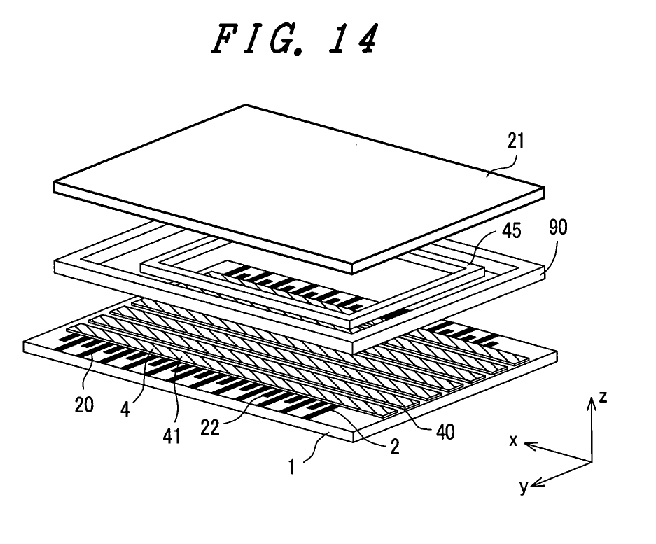

FIG. 14 is a developed perspective view for schematically showing the whole constitution of a display device of the present invention. The display device shown in FIG. 14 is based on the constitution of the third embodiment of the present invention shown in FIG. 5 and FIG. 6. In FIG. 14, on an inner surface of the back substrate 1, a large number of cathode lines 2 which extend in one direction (y direction) and are juxtaposed in another direction (x direction) which crosses the above-mentioned one direction are formed. Electron emitting sources such as carbon nanotubes are formed on face-substrate-21-side surfaces of cathode lines 2. Further, there are provided control electrodes 4 formed of a plurality of strip-like electrode elements 41 which extend in another direction (x direction) which crosses the cathode lines 2 and are juxtaposed in the above-mentioned one direction (y direction). In the drawing, electron passing apertures are omitted. Further, an anode and a fluorescent material are formed on the inner surface of the face substrate 21. The back substrate 1 and the face substrate 21 are sealed by the frame body 90.

A shield member 45 is provided inside a frame body 90 and terminals 22 of cathode lines 2 and an anode formed on an inner surface of a face substrate 21 are shielded from each other by the shield member 45. Video signals are supplied to the cathode lines 2 through cathode-line lead lines 20. Control signals (scanning signals) are supplied to the control electrodes 4 through control electrode lead terminals 40.

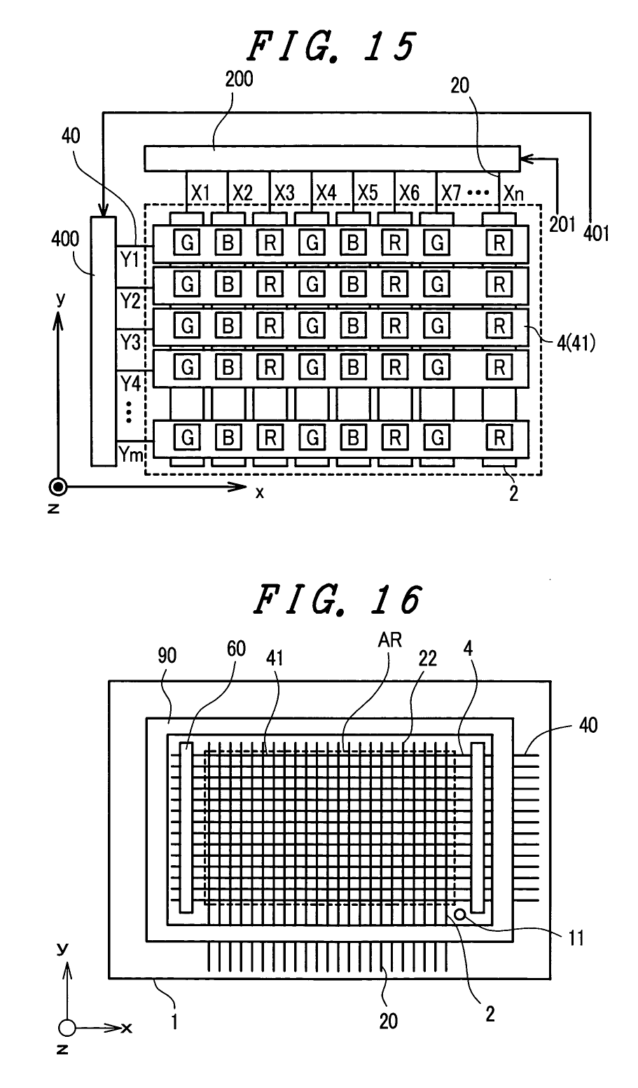

FIG. 15 is an explanatory view of an example of an equivalent circuit of the display device of the present invention. A region indicated by a broken line in the drawing indicates a display region. In the display region, the cathode lines 2 and the control electrodes 4 (strip-like electrode elements 41) are arranged to cross each other thus forming a matrix of n×m. Respective crossing portions of the matrix constitute unit pixels and one color pixel is constituted of a group of “R”, “G”, “B” in the drawing. The cathode lines 2 are connected to a video drive circuit 200 through the cathode-line lead lines 20 (X1, X2, . . . Xn), while the control electrodes 4 are connected to a scanning drive circuit 400 through control-electrode lead lines 40 (Y1, Y2, . . . Ym).

The video signals 201 are inputted to the video drive circuit 200 from an external signal source, while scanning signals (synchronous signals) 401 are inputted to the scanning drive circuit 400 in the same manner. Accordingly, given pixels which are sequentially selected by the strip-like electrode elements 41 and the cathode lines 2 emit light in given colors thus displaying two-dimensional images. With the use of the display device of the example having such a constitution, it is possible to realize a flat-panel type display device which can be operated with high efficiency at a relatively low voltage.

As has been explained in conjunction with embodiments, according to the typical constitutions of the present invention, by shielding the terminals of the cathode lines from the anode using the shield member, it is possible to prevent the generation of the spark and the dark current and to obviate the unstable display and degraded display whereby the display device which exhibits the long lifetime and the high reliability can be provided.

What is claimed is:

1. A display device comprising:
a face substrate which has an anode and a fluorescent material on an inner surface thereof;
a plurality of cathode lines which extend in one direction, are juxtaposed in another direction which crosses one direction, and has electron emitting sources;
control electrodes which are constituted by arranging a plurality of strip-like electrode elements which cross the cathode lines in a non-contact state within a display region, extend in the above-mentioned another direction and are juxtaposed in one direction, and have electron passing apertures for allowing electrons from the electron emitting sources to pass therethrough toward the face substrate;
a back substrate which has the control electrodes and the cathode lines on an inner surface thereof and faces the face substrate with a given distance therebetween; and
a frame body which is inserted between the face substrate and the back substrate and is arranged around the display region to hold the given distance, wherein
the cathode lines have extending one end sides thereof terminated outside the display region and inside the frame body, and a shield member is inserted between the terminals and the anode so as to ensure shielding between the terminals and the anode.

2. A display device according to claim 1, wherein the shield member is a member having the same shape as a strip-like electrode element which does not have the electron passing apertures.

3. A display device according to claim 1, wherein the shield member is a member having the same shape as a strip-like electrode element which has the electron passing apertures.

4. A display device according to claim 1, wherein the shield member is constituted of an insulation layer which covers the terminals.

5. A display device according to claim 1, wherein the shield member is constituted of a separate frame body which has a substantially same height as the frame body.

6. A display device comprising:
a face substrate which has an anode and a fluorescent material on an inner surface thereof;
a plurality of cathode lines which extend in one direction, are juxtaposed in another direction which crosses one direction, and has electron emitting sources;
control electrodes which are constituted by arranging a plurality of strip-like electrode elements which cross the cathode lines in a non-contact state within a display region, extend in the above-mentioned another direction and are juxtaposed in one direction, and have electron passing apertures for allowing electrons from the electron emitting sources to pass therethrough toward the face substrate;
a back substrate which has the control electrodes and the cathode lines on an inner surface thereof and faces the face substrate with a given distance therebetween; and
a frame body which is inserted between the face substrate and the back substrate and is arranged around the display region to hold the given distance, wherein
the cathode lines have extending one end sides thereof terminated at positions outside the display region and where the cathode lines are superposed on the frame body and the terminals and the anode are shielded from each other by the frame body.
